(19) United States
(12) Patent Application Publication
(10) Pub. No.: US 2026/0104972 A1
(43) Pub. Date: Apr. 16, 2026

(54) Data Processing Method, Switching Board, Data Processing System and Data Processing Apparatus

(71) Applicant: SUZHOU METABRAIN INTELLIGENT TECHNOLOGY CO., LTD., Suzhou, Jiangsu (CN)

(72) Inventors: Shunshun ZHANG, Suzhou, Jiangsu (CN); Xi CHEN, Suzhou, Jiangsu (CN); Xiaosong WANG, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 19/115,577

(22) PCT Filed: Aug. 1, 2024
(86) PCT No.: PCT/CN2024/109255

§ 371 Date: Mar. 26, 2025

(30) Foreign Application Priority Data
Sep. 6, 2023 (CN) 202311144706.0

(51) Int. Cl. G06F 11/20; G06F 13/40

(52) U.S. Cl. CPC G06F 11/2025; G06F 11/203; G06F 13/4022; G06F 2213/0026

(57) ABSTRACT

A data processing method, a switching board, a data processing system and a data processing apparatus are provided. The method includes: receiving a first fault instruction sent by a controller; on the basis of the first fault instruction, acquiring first target data; and transmitting the first target data to a second host system, so as to instruct the second host system to control a second processor to continue to process first data according to the first target data. wherein the second host system is a host system in a normal operating state among a plurality of host systems connected to a CXL switching device, and the second processor is a processor allocated to the second host system by the CXL switching device.

### CROSS-REFERENCE TO RELATED APPLICATION

The present application is a national stage filing under 35 U.S.C. § 371 of international application number PCT/CN2024/109255, filed Aug. 1, 2024, which claims priority to Chinese Patent Application No. 202311144706.0, filed to the China National Intellectual Property Administration on Sep. 6, 2023 and entitled “Data Processing Method, Switching Board, Data Processing System and Data Processing Apparatus”, the disclosure of which is hereby incorporated by reference in its entirety.

### TECHNICAL FIELD

Embodiments of the present disclosure relate to the field of computers, and in particular, to a data processing method, a switching board, a data processing system and a data processing apparatus.

### BACKGROUND

As more and more services are performed on a network, there are more and more application scenarios with the requirements for high concurrency and high computing power, such as Artificial Intelligence (AI), High Performance Computing (HPC), and cloud services. This leads to a significant demand for memory pool quantities in data centers. In addition, a large number of Peripheral Component Interconnect Express (PCI-Express, short as PCIe) computing accelerators are provided, which require massive amounts of cached data exchanges. In this case, the number of memories and memory segmentation may cause a huge waste of computing power and a degradation in performance. Therefore, cluster servers are gradually shifting from being compute-centric to being data-centric, making it extremely important to increase memory capacity and enhance cache coherence.

Additionally, the more data there is, the greater the risk it implies. A multitude of data, large or small, is continuously exchanged and calculated every day, and there are numerous reasons that may cause device failure, resulting in the loss of current computation data. After the device is restarted, all computations have to begin anew, which cannot meet the demands of scenarios that use massive computing models like AI, HPC, and cloud services. Therefore, ensuring the continuity of computing operations and guaranteeing that the system remains uninterrupted has become an urgent problem that needs to be addressed.

### SUMMARY

Embodiments of the present disclosure provide a data processing method, a switching board, a data processing system and a data processing apparatus, which may at least solve the problem in the related art that the continuity of data processing cannot be ensured.

According to a first aspect of the embodiments of the present disclosure, a data processing method is provided, which is applied to a Compute Express Link (CXL) switch device and includes: receiving a first fault instruction sent by a controller, where the first fault instruction is used for indicating that a fault occurs on a first host system, the first host system is configured to control a first processor to process first data, the first processor is an accelerator allocated to the first host system by the CXL switch device, and the CXL switch device is a device that supports a CXL protocol, which is an open interconnection standard; acquiring first target data based on the first fault instruction, where the first target data includes processing logic data according to which the first processor processes the first data, and first result data obtained after the first processor processes the first data; and transmitting the first target data to a second host system to instruct the second host system to control a second processor to continue processing the first data according to the first target data, where the second host system is a host system in a normal operating state among a plurality of host systems connected to the CXL switch device, and the second processor is a processor allocated to the second host system by the CXL switch device.

According to a second aspect of the embodiments of the present disclosure, a switching board is provided, which includes: a CXL switch device and a plurality of device interfaces, where the plurality of device interfaces are configured to allow, under control of the CXL switch device, a controller, a plurality of host systems, an expanded memory, and a plurality of processors to access the CXL switch device. The CXL switch device is configured to perform the data processing method.

According to a third aspect of the embodiments of the present disclosure, a data processing system is provided, which includes: a switching board, a controller, a plurality of host systems, an expanded memory, and a plurality of processors. A CXL switch device and a plurality of device interfaces are deployed on the switching board, the plurality of device interfaces are configured to allow, under control of the CXL switch device, the controller, the plurality of host systems, the expanded memory, and the plurality of processors to access the CXL switch device, and the CXL switch device is configured to perform the data processing method. The controller is configured to send a first fault instruction to the CXL switch device, where the first fault instruction is used for indicating that a fault occurs on a first host system among the plurality of host systems, the first host system is configured to control a first processor to process first data, and the first processor is an accelerator allocated to the first host system by the CXL switch device from the plurality of processors.

In an exemplary embodiment, the controller includes a target processor and a baseboard management controller. The baseboard management controller is connected to the plurality of host systems, and is configured to monitor operating states of the plurality of host systems, and send, when the plurality of host systems include a faulty host system, a faulty operating state of the faulty host system to the target processor. The target processor is configured to generate a fault instruction based on the faulty operating state, and the fault instruction includes system information corresponding to the faulty host system.

In an exemplary embodiment, the baseboard management controller is further configured to monitor the first host system through a plurality of signals, and send the faulty operating state of the first host system to the target processor when the plurality of signals all indicate that a fault occurs on the first host system. The target processor is configured to generate the first fault instruction based on the faulty operating state of the first host system.

In an exemplary embodiment, the baseboard management controller is further configured to restart the first host system, and send a fault recovery instruction to the target processor when the first host system is restarted, where the fault recovery instruction is used for indicating that the fault on the first host system has been repaired and the first host system is currently in a normal operating state.

In an exemplary embodiment, the controller may further include a programmable logic device. The programmable logic device is connected to the target processor and is configured to receive the fault recovery instruction sent by the target processor, and send the fault recovery instruction to the CXL switch device to instruct the CXL switch device to switch from a second host system to the first host system to continue processing the first data.

In an exemplary embodiment, the CXL switch device is further configured to allocate memories and processors to the plurality of host systems, where the allocated memories are memories in an idle state in the expanded memory, and the allocated processors are processors in an idle state among the plurality of processors.

In an exemplary embodiment, the expanded memory, the plurality of processors, and the plurality of host systems are all allowed to be connected to the plurality of device interfaces through CXL links under the control of the CXL switch device.

In an exemplary embodiment, the expanded memory, the plurality of processors, and the plurality of host systems are all allowed to be connected to the plurality of device interfaces through CXL links under the control of the CXL switch device.

According to a fourth aspect of the embodiments of the present disclosure, a data processing apparatus is provided, which includes: a first receiving module, configured to receive a first fault instruction sent by a controller, where the first fault instruction is used for indicating that a fault occurs on a first host system, the first host system is configured to control a first processor to process first data, the first processor is an accelerator allocated to the first host system by a CXL switch device, and the CXL switch device is a device that supports a CXL protocol, which is an open interconnection standard; a first acquisition module, configured to acquire first target data based on the first fault instruction, where the first target data includes processing logic data according to which the first processor processes the first data, and first result data obtained after the first processor processes the first data; and a first transmission module, configured to transmit the first target data to a second host system to instruct the second host system to control a second processor to continue processing the first data according to the first target data, where the second host system is a host system in a normal operating state among a plurality of host systems connected to the CXL switch device, and the second processor is a processor allocated to the second host system by the CXL switch device.

In an exemplary embodiment, the first receiving module includes a first receiving unit, configured to receive the first fault instruction sent by a target processor in the controller. The target processor is connected to a baseboard management controller, the baseboard management controller is connected to the plurality of host systems, and is configured to monitor operating states of the plurality of host systems, and send, when the plurality of host systems include a faulty host system, a faulty operating state of the faulty host system to the target processor, the target processor is configured to generate a fault instruction based on the faulty operating state, and the fault instruction includes system information corresponding to the faulty host system.

In an exemplary embodiment, the first acquisition module includes a first response unit, configured to acquire, in response to the first fault instruction, the processing logic data from a first memory corresponding to the first host system, and acquire the first result data from a first cache corresponding to the first processor, where the first memory is a memory in an idle state in an expanded memory allocated to the first host system by the CXL switch device, and the expanded memory is connected to the CXL switch device through a CXL link.

In an exemplary embodiment, the first transmission module includes a first storage unit, configured to store the processing logic data in a second memory corresponding to the second host system, and store the first result data in a second cache corresponding to the second processor, so as to instruct the second host system to control the second processor to continue processing first remaining data according to the processing logic data, where the first remaining data is data remaining after the first processor processes the first data, the second memory is a memory in an idle state in an expanded memory allocated to the second host system by the CXL switch device, and the expanded memory is connected to the CXL switch device through a CXL link.

In an exemplary embodiment, the data processing apparatus may further include a first cache module, configured to, after storing the first target data in the second memory corresponding to the second host system to instruct the second host system to control the second processor to continue processing the first remaining data according to the processing logic data and the first result data, cache, in the second cache, a current processing result obtained after the second processor processes the first remaining data and the first result data.

In an exemplary embodiment, the data processing apparatus may further include: a first allocation module, configured to, after acquiring the first target data based on the first fault instruction, allocate a first memory to one or more other host systems, where the one or more other host systems are one or more host systems in the normal operating state other than the first host system among the plurality of host systems connected to the CXL switch device, and the one or more other host systems include the second host system; and a second allocation module, configured to allocate the first processor to the one or more other host systems.

In an exemplary embodiment, the data processing apparatus may further include: a second receiving module, configured to, after acquiring the first target data based on the first fault instruction, receive a fault recovery instruction sent by a programmable logic device in the controller, where the fault recovery instruction is used for indicating that the fault on the first host system has been repaired and the first host system is currently in the normal operating state; a first response module, configured to allocate one or more other processors to the first host system in response to the fault recovery instruction, where the one or more other processors are one or more processors in an idle state among a plurality of processors connected to the CXL switch device, and the one or more other processors correspond to one or more other caches; and a third allocation module, configured to allocate one or more other memories to the first host system, where the one or more other memories are one or more memories in an idle state in an expanded memory connected to the CXL switch device.

In an exemplary embodiment, the data processing apparatus may further include: a second acquisition module, configured to, after allocating the one or more other memories to the first host system, acquire second target data from the second host system when the second host system is currently in a state of processing the first data, where the second target data includes the processing logic data, second result data obtained after the second processor continues processing the first data, and the first result data; and a second transmission module, configured to transmit the second target data to the first host system to instruct the first host system to control the one or more other processors to continue processing the first data according to the second target data.

In an exemplary embodiment, the second transmission module includes a second storage unit, configured to store the processing logic data in one or more other memories, and store second result data and first result data in the one or more other caches, so as to instruct the first host system to control one or more other processors to continue processing second remaining data according to the processing logic data, where the second remaining data is data remaining after the second processor processes the first data.

According to a fifth aspect of the embodiments of the present disclosure, a computer non-volatile readable storage medium is provided, in which a computer program is stored. The computer program, when running on a processor, is configured to execute operations in any one of the above method embodiments.

According to a sixth aspect of the embodiments of the present disclosure, an electronic device is further provided, which includes a memory and a processor. A computer program is stored in the memory, and the processor is configured to run the computer program to execute operations in any one of the above method embodiments.

Through the embodiments of the present disclosure, when a fault occurs on the first host system, the controller sends the first fault instruction to the CXL switch device, and the CXL switch device transfers and stores the first data controlled and processed by the first host system to the second host system, and the second host system continues processing the first data. That is, the first data is not interrupted by the fault of the first host system, but continues to be processed by the second host system through the allocation of the CXL switch device. The continuity of data processing is ensured. Therefore, the problem in the related art that the continuity of data processing cannot be ensured may be solved, thereby achieving the effect of ensuring the continuity of data processing.

### BRIEF DESCRIPTION OF THE DRAWINGS

FIG. 1 is a block diagram of a hardware structure of a mobile terminal for implementing a data processing method according to an embodiment of the present disclosure.

FIG. 2 is a flowchart of a data processing method according to an embodiment of the present disclosure.

FIG. 3 is a schematic diagram of implementing memory capacity expansion in a cluster server according to an embodiment of the present disclosure.

FIG. 4 is a schematic diagram of connections among various devices according to an embodiment of the present disclosure.

FIG. 5 is a flowchart of implementing a checkpoint resumption function according to an embodiment of the present disclosure.

FIG. 6 is a structural block diagram of a data processing apparatus according to an embodiment of the present disclosure.

### DETAILED DESCRIPTION OF THE EMBODIMENTS

Embodiments of the present disclosure are described below with reference to the drawings and in conjunction with the embodiments in detail.

It is to be noted that terms “first”, “second” and the like in the specification, claims and the above drawings of the present disclosure are used for distinguishing similar objects rather than describing a specific sequence or a precedence order.

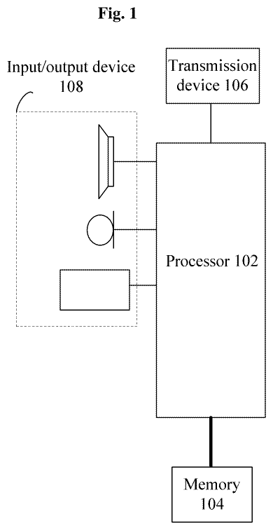

The method embodiments provided in the embodiments of the present disclosure may be implemented in a mobile terminal, a computer terminal or a similar computing apparatus. Taking running on the mobile terminal as an example, FIG. 1 is a block diagram of a hardware structure of a mobile terminal for implementing a data processing method according to an embodiment of the present disclosure. As shown in FIG. 1, the mobile terminal may include one or more (only one is shown in FIG. 1) processors 102 (the one or more processors 102 may include, but are not limited to, a Micro Processor Unit (MCU) or a programmable logic device Field Programmable Gate Array (FPGA), and other processing apparatuses), and a memory 104 configured to store data. The above mobile terminal may further include a transmission device 106 configured to achieve a communication function and an input/output device 108. Those having ordinary skill in the art may understand that the structure shown in FIG. 1 is only schematic and not intended to limit the structure of the above mobile terminal. For example, the mobile terminal may further include more or fewer components than those shown in FIG. 1, or have a different configuration from that shown in FIG. 1.

The memory 104 is configured to store a computer program, for example, a software program or a module of application software, such as a computer program corresponding to the data processing method in the embodiments of the present disclosure. The one or more processors 102 may run the computer program stored in the memory 104 to perform various functional applications and data processing, that is, to implement the above data processing method. The memory 104 may include a high speed Random Access Memory (RAM), and may alternatively include a non-volatile memory such as one or more magnetic storage apparatuses, a flash memory, or other non-volatile solid state memories. In some examples, the memory 104 includes a memory remotely located with respect to the one or more processors 102, which may be connected to the mobile terminal over a network. Examples of the above network include, but are not limited to, the Internet, the Intranet, a local area network, a mobile communication network, and a combination thereof.

The transmission module 106 is configured to receive or transmit data through a network. The above examples of the network may include a wireless network provided by a communication provider of the mobile terminal. In an example, the transmission device 106 includes a Network Interface Controller (NIC) that may be connected to other network devices through a base station to communicate with the Internet. In an example, the transmission device 106 may be a Radio Frequency (RF) module, which is configured to communicate with the Internet in a wireless manner.

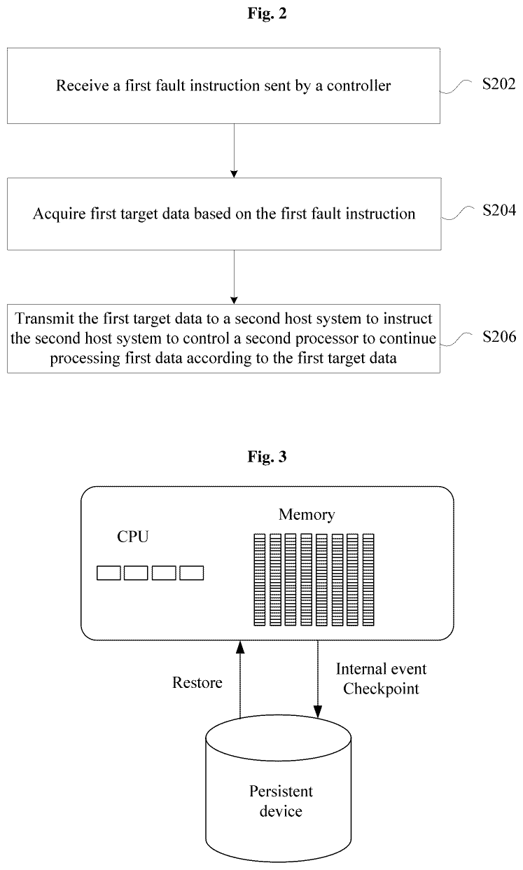

In the present embodiment, a data processing method is provided, which is applied to a CXL switch device. FIG. 2 is a flowchart of a data processing method according to an embodiment of the present disclosure. As shown in FIG. 2, the flow includes the following operations S202 to S206.

At S202, a first fault instruction sent by a controller is received, where the first fault instruction is used for indicating that a fault occurs on a first host system, the first host system is configured to control a first processor to process first data, the first processor is an accelerator allocated to the first host system by the CXL switch device, and the CXL switch device is a device that supports a CXL protocol, which is an open interconnection standard.

At S204, first target data is acquired based on the first fault instruction, where the first target data includes processing logic data according to which the first processor processes the first data, and first result data obtained after the first processor processes the first data.

At S206, the first target data is transmitted to a second host system to instruct the second host system to control a second processor to continue processing the first data according to the first target data, where the second host system is a host system in a normal operating state among a plurality of host systems connected to the CXL switch device, and the second processor is a processor allocated to the second host system by the CXL switch device.

Through the above operations, when a fault occurs on the first host system, the controller sends the first fault instruction to the CXL switch device, and the CXL switch device transfers and stores the first data controlled and processed by the first host system to the second host system, and the second host system continues processing the first data. That is, the first data is not interrupted by the fault on the first host system, but continues to be processed by the second host system through the allocation of the CXL switch device. The continuity of data processing is ensured. Therefore, the problem in the related art that the continuity of data processing cannot be ensured may be solved, thereby achieving the effect of ensuring the continuity of data processing.

In some exemplary embodiments, the CXL switch device includes, but is not limited to, a device having an interface switching function and a resource allocation function, such as a CXL Switch. A first memory and a second memory are both memories in an expanded memory connected to the CXL Switch. The first processor and the second processor are also processors in a plurality of processors mounted in the CXL Switch.

In some exemplary embodiments, the first fault instruction includes system information of the first host system, such as a name and an identification of the first host system. The processor and the memory corresponding to the first host system may be allocated by the CXL switch device, and are not limited by the memory of the first host system, so that the memory may be expanded effectively.

In some exemplary embodiments, the processing logic data of the first data includes one or more operations required to be performed for processing the first data, for example, processing the first data by sequentially performing operations S1, S2, and S3. A first processing result includes partial results of processing the first data. For example, the first processing result may be a processing result obtained by performing the operations S1 and S2. By transferring and storing the processing logic data of the first data to the second host system, the second processor corresponding to the second host system may know which operation(s) to perform in order to continue processing the first data. By transferring and storing the first result data to the second host system, it is beneficial for the second host system to acquire a complete processing result.

In some exemplary embodiments, the plurality of host systems are connected to the CXL switch device, all of which are connected through CXL links. Required resources (e.g., the memory and the processor) are allocated to each host system. Therefore, memory expansion and allocation of processing resources of a cluster server may be achieved. For example, as shown in FIG. 3, which is a schematic diagram of implementing memory expansion in a cluster server, a Central Processing Unit (CPU) itself has a memory, and capacity expansion is achieved through a persistent device, which may ensure that when the host system crashes, computing cache data of the host system may be completely saved, a computing service is not lost, and the computing service continues after the node is restored. It is to be noted that the CXL switch device preferentially allocates resources in an idle state to the host system. Fixed resources may also be allocated, for example, a first memory, a second memory, and a first processor are allocated to the first host system, and a third memory, a fourth memory, and a second processor are allocated to the second host system. The first processor and the second processor include, but are not limited to, an accelerator.

In an exemplary embodiment, the operation that a first fault instruction sent by a controller is received includes: receiving the first fault instruction sent by a target processor in the controller. The target processor is connected to a baseboard management controller, the baseboard management controller is connected to the plurality of host systems, and is configured to monitor operating states of the plurality of host systems, and send, when the plurality of host systems include a faulty host system, a faulty operating state of the faulty host system to the target processor, the target processor is configured to generate a fault instruction based on the faulty operating state, and the fault instruction includes system information corresponding to the faulty host system.

In some exemplary embodiments, the target processor may be a device having a data processing function, such as a CPU, a Graphics Processing Unit (GPU), a mobile (m)CPU, etc. The baseboard management controller may be a device having a device monitoring function, such as a Baseboard Management Controller (BMC). The BMC may monitor operating states of the plurality of host systems at the same time by using two management signals (mCpu_heartError and SMI_GPIO). The BMC communicates with the mCPU through a Low Pin Count (LPC) bus/Inter-Integrated Circuit (IIC) to transmit the first fault instruction. The BMC monitors the operating states of the plurality of host systems. In order to prevent misjudgment caused by interference on a single link, the BMC may wait for two monitoring feedback signals of the first host system. Only when an alarm is triggered through both of the two monitoring feedback signals (mCpu_heartError and SMI_GPIO), the BMC may determine that the host system is in a fault state.

In the present embodiment, the BMC monitors the host system, so that whether a fault occurs on the host system may be determined in time, thereby switching data processing in time, and ensuring uninterrupted data processing.

In an exemplary embodiment, the operation that first target data is acquired based on the first fault instruction includes: in response to the first fault instruction, acquiring the processing logic data from the first memory corresponding to the first host system, and acquiring the first result data from a first cache corresponding to the first processor, where the first memory is a memory in an idle state in the expanded memory allocated to the first host system by the CXL switch device, and the expanded memory is connected to the CXL switch device through a CXL link.

In some exemplary embodiments, after receiving the first fault instruction, the CXL switch device first extracts fault information to determine that a fault occurs on the first host system. Then, the processing logic data is read from the first memory corresponding to the first host system, the first result data is read from the first cache, and then the two pieces of data (i.e., the processing logic data and the first result data) are transferred and stored to the second host system in the idle state for continued processing. The first memory and the first processor are both allocated by the CXL switch device according to the resource requirements of the first host system. In the present embodiment, by transferring and storing the data in time, the computational cache data may be completely saved, it is ensured that the computing service is not lost, and the data continues to be processed in time.

In an exemplary embodiment, the operation that the first target data is transmitted to a second host system to instruct the second host system to control a second processor to continue processing first data according to the first target data includes: storing the processing logic data in the second memory corresponding to the second host system, and storing the first result data in a second cache corresponding to the second processor, so as to instruct the second host system to control the second processor to continue processing first remaining data according to the processing logic data, where the first remaining data is data remaining after the first processor processes the first data, the second memory is a memory in an idle state in an expanded memory allocated to the second host system by the CXL switch device, and the expanded memory is connected to the CXL switch device through a CXL link.

In some exemplary embodiments, the second memory and the second processor are allocated by the CXL switch device according to the resource requirements of the second host system. The second memory and the second processor may be allocated before the first target data is transferred and stored, or may be temporarily allocated when determining that the data needs to be transferred and stored. The second host system may be a system having the same function as the first host system, or a backup host system of the first host system. In the present embodiment, by transferring and storing the data to the second host system in time for continued processing, it may be ensured that the computing service is not lost and the data may continue to be processed in time.

In an exemplary embodiment, after storing the first target data in the second memory corresponding to the second host system to instruct the second host system to control the second processor to continue processing the first remaining data according to the processing logic data and the first result data, the above data processing method may further include: caching, in the second cache, a current processing result obtained after the second processor processes the first remaining data and the first result data.

In some exemplary embodiments, the second processor needs to cache the processed data in time and merge the processed result data with the first result data to ensure the integrity of the processing result. After the first data is processed, the cached complete data may be stored in the second memory for long-term saving, or may alternatively be transmitted to the memory in the second host system for saving, or may alternatively be stored in a memory reallocated by the CXL switch device.

In an exemplary embodiment, after acquiring the first target data based on the first fault instruction, the data processing method may further include: allocating the first memory to one or more other host systems, where the one or more other host systems are one or more host systems in the normal operating state other than the first host system among the plurality of host systems connected to the CXL switch device, and the one or more other host systems include the second host system; and allocating the first processor to the one or more other host systems.

In some exemplary embodiments, after a fault occurs on the first host system and the data processing logic and the first result data are transferred and stored, the first memory and the first processor are both in the idle state, and the CXL switch device releases the association with the first host system. The first memory and the first processor are allocated to one or more other host systems that need the resources. For example, the first memory and the first processor may be allocated to a second host system or a third host system, which may not only fully utilize the resources, but also alleviate the data processing pressure of the other host systems.

In an exemplary embodiment, after acquiring the first target data based on the first fault instruction, the above data processing method may further include: receiving a fault recovery instruction sent by a programmable logic device in the controller, where the fault recovery instruction is used for indicating that the fault on the first host system has been repaired and the first host system is currently in the normal operating state; allocating one or more other processors to the first host system in response to the fault recovery instruction, where the one or more other processors are one or more processors in an idle state among a plurality of processors connected to the CXL switch device, and the one or more other processors correspond to one or more other caches; and allocating one or more other memories to the first host system, where the one or more other memories are one or more memories in an idle state in an expanded memory connected to the CXL switch device.

In some exemplary embodiments, the programmable logic device includes, but is not limited to, a device having a reset function, such as a Complex Programmable Logic Device (CPLD). The BMC communicates with the mCPU and the CPLD through the LPC/IIC to transmit the first fault instruction. The mCPU and the CPLD perform state allocation and reset actions on the CXL switch device through a Universal Asynchronous Receiver/Transmitter (UART). In addition, after completing the control of the caching of the first target data, the BMC and the CPLD restart the faulty first host system. When the faulty first host system is successfully restarted, an upper-level user device may be notified through the BMC to complete the restart. During the restart of the first host system, all devices are mounted to the second host system and operate normally, and may not affect the progress of the computing service.

In some exemplary embodiments, after receiving the fault recovery instruction, the CXL switch device performs resource recovery on the first host system again, and if the first processor and the first memory are in the idle state, the first processor and the first memory are also mounted to the first host system. If the first processor and the first memory have been mounted to the other host systems, one or more other processors and memories are remounted to the first host system.

In some exemplary embodiments, after allocating the one or more other memories to the first host system, the above data processing method may further include: allocating second target data from the second host system when the second host system is currently in a state of processing the first data, where the second target data includes the processing logic data, second result data obtained after the second processor continues processing the first data, and the first result data; and transmitting the second target data to the first host system to instruct the first host system to control the one or more other processors to continue processing the first data according to the second target data. In the present embodiment, when the second host system is currently in the state of processing the first data, it indicates that the processing of the first data is not completed yet, and the first host system may be switched for continued processing. The process of switching to the first host system is the same as the process of switching to the second host system, which will not be elaborated here. It is to be noted that, when the second host system is the backup system of the first host system, the first host system, as a main processing system, mainly undertakes the function of data processing after the fault is repaired. After the first host system is restored, if the second host system has completed processing the first data, the CXL switch device also needs to transfer and store the complete processing result to the first host system, so that the processing result is analyzed by the first host system.

In some exemplary embodiments, the operation of transmitting the second target data to the first host system to instruct the first host system to control the one or more other processors to continue processing the first data according to the second target data includes: storing the processing logic data in the one or more other memories, and storing the second result data and the first result data in the one or more other caches, so as to instruct the first host system to control the one or more other processors to continue processing second remaining data according to the processing logic data, where the second remaining data is data remaining after the second processor processes the first data. In the present embodiment, when the first host system continues processing the second remaining data, the CXL switch device may release the resources of the second host system, and transfer and store the data in time to ensure the timely storage of the data.

In an exemplary embodiment, when the CXL switch device is a CXL Switch, the first host system is a HOSTO, the second host system is a HOST1, and the controller includes the BMC, the mCPU, and the CPLD, the CXL switch device and a CXL Expander implement memory expansion and management through the CXL protocol. The BMC monitors the operating states of the HOSTs simultaneously. When a fault occurs on a certain HOST, the BMC sends the switching information to the mCPU and the CPLD, and the mCPU and the CPLD send a computing port switching instruction to the CXL switch device, and perform save and write operations on the current data cache at the same time. After switching to a normal HOST, the computing service is continued according to the cached data in the memory. When the faulty HOST returns to normal, the current computing service is switched back to the HOST that returns to normal, thereby achieving a service checkpoint resumption function.

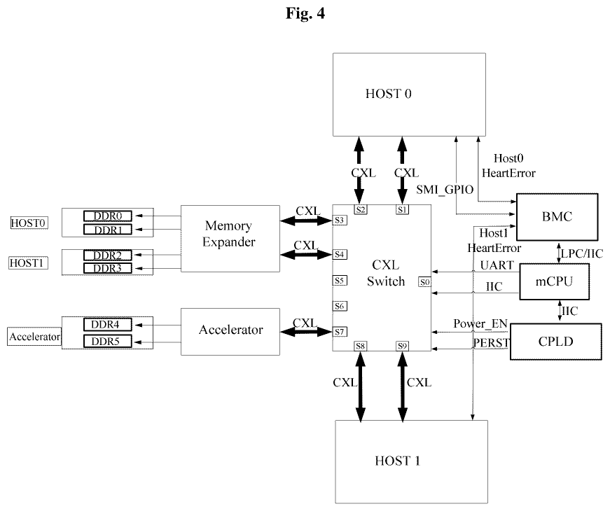

In some exemplary embodiments, in the normal operating state, the HOST is interconnected with the CXL Switch and the CXL Expander through the CXL link, and the accelerator responsible for data processing and HPC is also interconnected with the CXL Switch through the CXL link. Each HOST has a heartbeat monitor link (mCpu_heartError) and an abnormal interrupt alarm link (SMI_GPIO) connected to the BMC. The BMC monitors the operating state of each HOST in real time through the heartbeat monitoring link and the interrupt alarm link. When the BMC monitors that the heartbeat of a certain HOST is abnormal, the BMC may communicate with the mCPU and the CPLD through a Serial Peripheral Interface (SPI)/IIC link, save the current computing data through the CXL Switch, and then mount the memory to a normally operating HOST by configuring the CXL Switch, so as to continue the computing service. At the same time, the faulty HOST is restarted through a control link. When the faulty HOST is successfully restarted and resumes normal operation, the mCPU and the CPLD restore the CXL Switch to the initial configuration and return the computing service to the original HOST, which can not only expand the memory capacity of the cluster server, but also achieve the checkpoint resumption function through cache consistency, so as to ensure that when a certain node in the system crashes, the computing cache data of the node may be completely saved, the computing service is not lost, and the computing service continues after the node is restored. In some exemplary embodiments, as shown in FIG. 4, the present embodiment includes the following operations S1 to S7.

At S1, the HOST is interconnected with the CXL Switch, the CXL Expander and the Accelerator through a CXL signal. The CXL Expander expands memory capacity through the CXL link. The Accelerator is mounted to the HOST through the CXL link to perform accelerated computing service. A monitoring and management switching implementation solution is based on the BMC, the mCPU, and the CPLD. The BMC monitors the operating state of each HOST at the same time by using two management signals (mCpu_heartError and SMI_GPIO). The BMC communicates with the mCPU and the CPLD through the LPC/IIC to transmit the switching instruction. The mCPU and the CPLD perform state allocation and reset actions on the CXL Switch through the UART.

At S2, the BMC monitors the operating state of each HOST. In order to prevent misjudgment caused by interference on a single link, the BMC may wait for the two monitoring feedback signals of the HOST. Only when an alarm is triggered through both of the two monitoring feedback signals (mCpu_heartError and SMI_GPIO), the BMC may determine that the HOST is in a fault state.

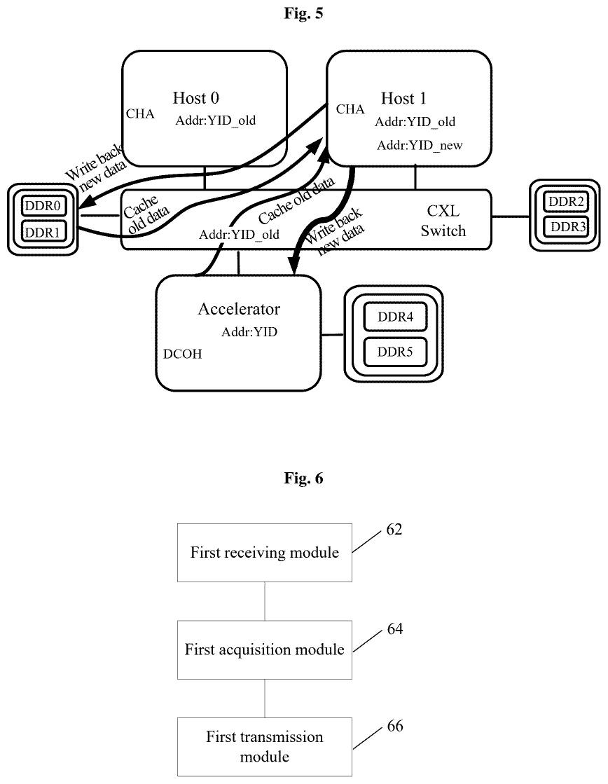

At S3, extended memories, e.g., Double Data Rate Synchronous Dynamic Random-Access Memories (DDRs) denoted as DDR0, DDR1, DDR2, and DDR3 are mounted to the CXL Switch through the CXL Expander, and address space is allocated to the extended memories through the CXL Switch, which are respectively mounted to the HOST0 and the HOST1. The Accelerator communicates with the HOST0 through the CXL Switch to perform related computing services, and caches computing data in DDR4 and DDR5. When the BMC notifies the mCPU of the fault state through an LPC/IIC signal, the mCPU communicates with the CXL Switch through the UART. Assuming that a fault occurs on the HOST0, then checkpoint resumption is performed according to the operations shown in FIG. 5, which include that: the CXL Switch first accesses and saves data in DDR0 and DDR1 mounted to the HOST0, and then verifies and saves the data in the Accelerator that interacts with the HOST0 and performs the computing service, so as to ensure that the data in DDR4 and DDR5 are the latest content, and these latest data are named Date_old.

At S4, all old data (Date_old) is cached into the memory space of the HOST1 through the CXL switch device. At the same time, the mCPU notifies the CXL Switch of a change in the internal register configuration and resets the Accelerator.

At S5, the Accelerator caches the old data in the HOST1 into a memory of the Accelerator and continues performing the computing service from the last checkpoint. The new data generated by the continued computing service is defined as Date_new.

At S6, the BMC and the CPLD restart the faulty HOST0 after completing caching the old data. When the faulty HOST0 is restarted successfully, the upper-layer user device may be notified through the BMC to complete the restart. During the restart of the HOST0, all devices are mounted to the HOST1 and operate normally, and may not affect the computing service.

At S7, when the faulty HOST0 is restarted successfully, the operations from S3 to S5 are repeated, the latest computation results are cached in DDR0, DDR1, DDR4 and DDR5, and the Accelerator continues the computing process based on the latest computed results. In the whole process, during the failure of the HOST0, the computational data at the checkpoint is saved in the HOST1 and the computing service continues. After the HOST0 is restarted, the new computational data in the HOST1 is written back to the HOST0, and the computing service continues from the new checkpoint, thereby achieving the checkpoint resumption function.

The embodiments of the present disclosure may expand the memory capacity of the cluster server and complete the checkpoint resumption function by achieving cache consistency, which ensures that when the node in the system crashes, the computing cache data of the node may be completely stored, the computing service is not lost, and the computing service continues after the node is restored. The problem that the memory capacity of the cluster server cannot be effectively expanded and cache inconsistency exists may be effectively solved. In addition, the problem that when the node in the system crashes, the computational data of the node cannot be completely saved and the checkpoint resumption function cannot be achieved, which may bring heavy economic losses may also be effectively solved.

In the present embodiment, a switching board is provided, which includes: a CXL switch device and a plurality of device interfaces, where the plurality of device interfaces are configured to allow, under control of the CXL switch device, a controller, a plurality of host systems, an expanded memory, and a plurality of processors to access the CXL switch device. The CXL switch device is configured to perform the above data processing method.

In some exemplary embodiments, the CXL switch device includes, but is not limited to, a device having an interface switching function and a resource allocation function, such as a CXL Switch. The expanded memory, which includes a plurality of memories, such as a first memory and a second memory, is mounted to the CXL switch device. A plurality of processors, such as a first processor and a second processor, are also mounted to the CXL switch device.

In some exemplary embodiments, as shown in FIG. 4, a plurality of device interfaces, including S0-S9, may be connected to different devices. For example, the CXL Switch may be connected to an mCPU through S0.

Through the above switching board, when a fault occurs on a first host system, a controller sends a first fault instruction to the CXL switch device, and the CXL switch device transfers and stores the first data controlled and processed by the first host system to a second host system, and the second host system continues processing the first data. That is, the first data is not interrupted by the fault on the first host system, but continues to be processed by the second host system through the allocation of the CXL switch device. The continuity of data processing is ensured. Therefore, the problem in the related art that the continuity of data processing cannot be ensured may be solved, thereby achieving the effect of ensuring the continuity of data processing.

In the present embodiment, a data processing system is provided, which includes: a switching board, a controller, a plurality of host systems, an expanded memory, and a plurality of processors. A CXL switch device and a plurality of device interfaces are deployed on the switching board, the plurality of device interfaces are configured to allow, under control of the CXL switch device, the controller, the plurality of host systems, the expanded memory, and the plurality of processors to access the CXL switch device, and the CXL switch device is configured to perform the data processing method. A controller is configured to send a first fault instruction to the CXL switch device, where the first fault instruction is used for indicating that a fault occurs on a first host system among the plurality of host systems, the first host system is configured to control a first processor to process first data, and the first processor is an accelerator allocated to the first host system by the CXL switch device from the plurality of processors.

Through the above data processing system, when a fault occurs on the first host system, the controller sends the first fault instruction to the CXL switch device, and the CXL switch device transfers and stores the first data controlled and processed by the first host system to a second host system, and the second host system continues processing the first data. That is, the first data is not interrupted by the fault on the first host system, but continues to be processed by the second host system through the allocation of the CXL switch device. The continuity of data processing is ensured. Therefore, the problem in the related art that the continuity of data processing cannot be ensured may be solved, thereby achieving the effect of ensuring the continuity of data processing.

In some exemplary embodiments, the CXL switch device includes, but is not limited to, a device having an interface switching function and a resource allocation function, such as a CXL Switch. A first memory and a second memory are both memories in an expanded memory connected to the CXL Switch. The first processor and the second processor are also processors in a plurality of processors mounted in the CXL switch device.

In some exemplary embodiments, the first fault instruction includes system information of the first host system, such as a name and an identification of the first host system. The processor and the memory corresponding to the first host system may be allocated by the CXL switch device, and are not limited by the memory of the first host system, so that the memory may be expanded effectively.

In some exemplary embodiments, the processing logic data of the first data includes one or more operations required to be performed for processing the first data, for example, processing the first data by sequentially performing operations S1, S2, and S3. A first processing result includes partial results of processing the first data. For example, the first processing result may be a processing result obtained by performing the operations S1 and S2. By transferring and storing the processing logic data of the first data to the second host system, the second processor corresponding to the second host system may know which operation(s) to perform in order to continue processing the first data. By transferring and storing the first result data to the second host system, it is beneficial for the second host system to acquire a complete processing result.

In some exemplary embodiments, the plurality of host systems are connected to the CXL switch device, all of which are connected through CXL links. Required resources (e.g., the memory and the processor) are allocated to each host system. Therefore, memory expansion and allocation of processing resources of a cluster server may be achieved. For example, as shown in FIG. 3, which is a schematic diagram of implementing memory expansion in a cluster server, a CPU itself has a memory, and capacity expansion is achieved through a persistent device, which may ensure that when the host system crashes, computing cache data of the host system may be completely saved, a computing service is not lost, and the computing service continues after the node is restored. It is to be noted that the CXL switch device preferentially allocates resources in an idle state to the host system. Fixed resources may also be allocated, for example, a first memory, a second memory, and a first processor are allocated to the first host system, and a third memory, a fourth memory, and a second processor are allocated to the second host system. The first processor and the second processor include, but are not limited to, an accelerator.

In an exemplary embodiment, the controller includes a target processor and a BMC. The BMC is connected to the plurality of host systems, and is configured to monitor operating states of the plurality of host systems, and send, when the plurality of host systems include a faulty host system, a faulty operating state of the faulty host system to the target processor. The target processor is configured to generate a fault instruction based on the faulty operating state, and the fault instruction includes system information corresponding to the faulty host system.

In some exemplary embodiments, the target processor may be a device having a data processing function, such as the CPU, a GPU, mCPU, etc. The baseboard management controller may be a device having a device monitoring function, such as a BMC. The BMC may monitor operating states of the plurality of host systems at the same time by using two management signals (mCpu_heartError and SMI_GPIO). The BMC communicates with the mCPU through an LPC bus/IIC to transmit the first fault instruction. The BMC monitors the operating states of the plurality of host systems. In order to prevent misjudgment caused by interference on a single link, the BMC may wait for two monitoring feedback signals of the first host system. Only when an alarm is triggered through both of the two monitoring feedback signals (mCpu_heartError and SMI_GPIO), the BMC may determine that the host system is in a fault state.

In the present embodiment, the baseboard management controller monitors the host system, so that whether a fault occurs on the host system may be determined in time, thereby switching data processing in time, and ensuring uninterrupted data processing.

In an exemplary embodiment, the baseboard management controller is further configured to monitor the first host system through a plurality of signals, and send the faulty operating state of the first host system to the target processor when the plurality of signals all indicate that a fault occurs on the first host system. The target processor is configured to generate the first fault instruction based on the faulty operating state of the first host system.

In an exemplary embodiment, the baseboard management controller is further configured to restart the first host system, and send a fault recovery instruction to the target processor when the first host system is restarted, where the fault recovery instruction is used for indicating that the fault of the first host system has been repaired and the first host system is currently in a normal operating state.

In an exemplary embodiment, the controller may further include a programmable logic device. The programmable logic device is connected to the target processor and is configured to receive the fault recovery instruction sent by the target processor, and send the fault recovery instruction to the CXL switch device to instruct the CXL switch device to switch the second host system to the first host system to continue processing the first data.

In some exemplary embodiments, the programmable logic device includes, but is not limited to, a device having a reset function, such as a CPLD. The BMC communicates with the mCPU and the CPLD through the LPC/IIC to transmit the first fault instruction. The mCPU and the CPLD perform state allocation and reset actions on the CXL switch device through an UART. In addition, after completing the control of the caching of the first target data, the BMC and the CPLD restart the faulty first host system. When the faulty first host system is successfully restarted, an upper-level user device may be notified through the BMC to complete the restart. During the restart of the first host system, all devices are mounted to the second host system and operate normally, and may not affect the progress of the computing service.

In an exemplary embodiment, the CXL switch device is further configured to allocate memories and processors to the plurality of host systems, where the allocated memories are memories in an idle state in the expanded memory, and the allocated processors are processors in an idle state among the plurality of processors.

In an exemplary embodiment, the expanded memory, the plurality of processors, and the plurality of host systems are all allowed to be connected to the plurality of device interfaces through CXL links under the control of the CXL switch device.

Through the above description of implementations, those having ordinary skill in the art may clearly know that the data processing method according to the above embodiments may be implemented by means of software plus a necessary common hardware platform, certainly by means of hardware; but in many cases, the former is the better implementation. Based on such understanding, the technical solution of the present disclosure, which is essential or contributes to the related art, may be embodied in the form of a software product. The computer software product is stored in a non-volatile readable storage medium (such as a Read-Only Memory (ROM)/Random Access Memory (RAM), a magnetic disk and an optical disc), including a number of instructions for causing a terminal device (which may be a mobile phone, a computer, a server, or a network device, etc.) to perform the methods described in various embodiments of the present disclosure.

In the present embodiment, a data processing apparatus is further provided. The data processing apparatus is configured to implement the above embodiments and exemplary implementations. The embodiments and exemplary implementations that have been elaborated will not be repeated here. The term “module” used below can realize a combination of software and/or hardware with an intended function. Although the data processing apparatus described in the following embodiment is preferably realized by software, but the data processing apparatus realized by hardware or a combination of software and hardware is also possible and conceived.

FIG. 6 is a structural block diagram of a data processing apparatus according to an embodiment of the present disclosure. As shown in FIG. 6, the data processing apparatus includes: a first receiving module 62, a first acquisition module 64, and a first transmission module 66.

The first receiving module 62 is configured to receive a first fault instruction sent by a controller, where the first fault instruction is used for indicating that a fault occurs on a first host system, the first host system is configured to control a first processor to process first data, the first processor is an accelerator allocated to the first host system by the CXL switch device, and the CXL switch device is a device that supports a CXL protocol, which is an open interconnection standard.

The first acquisition module 64 is configured to acquire first target data based on the first fault instruction, where the first target data includes processing logic data of the first processor processing the first data and first result data of the first processor processing the first data.

The first transmission module 66 is configured to transmit the first target data to a second host system to instruct the second host system to control a second processor to continue processing the first data according to the first target data, where the second host system is a host system in a normal operating state among a plurality of host systems connected to the CXL switch device, and the second processor is a processor allocated to the second host system by the CXL switch device.

In an exemplary embodiment, the first receiving module 62 includes a first receiving unit, configured to receive the first fault instruction sent by a target processor in the controller. The above target processor is connected to a baseboard management controller, the baseboard management controller is connected to a plurality of host systems, and is configured to monitor the operating states of the plurality of host systems, and send, when the plurality of host systems include a faulty host system, a faulty operating state of the faulty host system to the target processor, the target processor is configured to generate a fault instruction based on the faulty operating state, and the fault instruction includes system information corresponding to the faulty host system.

In an exemplary embodiment, the first acquisition module 64 includes a first response unit, configured to acquire, in response to the first fault instruction, the processing logic data from a first memory corresponding to the first host system, and acquire the first result data from a first cache corresponding to the first processor, where the first memory is a memory in an idle state in an expanded memory allocated to the first host system by the CXL switch device, and the expanded memory is connected to the CXL switch device through a CXL link.

In an exemplary embodiment, the first transmission module 66 includes a first storage unit, configured to store the processing logic data in a second memory corresponding to the second host system, and store the first result data in a second cache corresponding to the second processor, so as to instruct the second host system to control the second processor to continue processing first remaining data according to the processing logic data, where the first remaining data is data remaining after the first processor processes the first data, the second memory is a memory in an idle state in the expanded memory allocated to the second host system by the CXL switch device, and the expanded memory is connected to the CXL switch device through a CXL link.

In an exemplary embodiment, the data processing apparatus may further include a first cache module, configured to, after storing the first target data in the second memory corresponding to the second host system to instruct the second host system to control the second processor to continue processing the first remaining data according to the processing logic data and the first result data, cache a current processing result of the second processor processing the first remaining data and the first result data in the second cache.

In an exemplary embodiment, the data processing apparatus may further include: a first allocation module, configured to, after acquiring the first target data based on the first fault instruction, allocate the first memory to one or more other host systems, where the other host systems are one or more host systems in the normal operating state other than the first host system among the plurality of host systems connected to the CXL switch device, and the other host systems include the second host system; and a second allocation module, configured to allocate the first processor to the other host systems.

In an exemplary embodiment, the data processing apparatus may further include: a second receiving module, configured to, after acquiring the first target data based on the first fault instruction, receive a fault recovery instruction sent by a programmable logic device in the controller, where the fault recovery instruction is used for indicating that a fault of the first host system has been repaired and the first host system is currently in the normal operating state; a first response module, configured to allocate one or more other processors to the first host system in response to the fault recovery instruction, where the one or more other processors are one or more processors in an idle state among a plurality of processors connected to the CXL switch device, and the one or more other processors correspond to one or more other caches; and a third allocation module, configured to allocate one or more other memories to the first host system, where the one or more other memories are one or more memories in an idle state in an expanded memory connected to the CXL switch device.

In an exemplary embodiment, the data processing apparatus may further include: a second acquisition module, configured to, after allocating the one or more other memories to the first host system, acquire second target data from the second host system when the second host system is currently in a state of processing the first data, where the second target data includes the processing logic data, second result data of the second processor continuing processing the first data, and the first result data; and a second transmission module, configured to transmit the second target data to the first host system to instruct the first host system to control the one or more other processors to continue processing the first data according to the second target data.

In an exemplary embodiment, the second transmission module includes a second storage unit, configured to store the processing logic data in the one or more other memories, and store the second result data and the first result data in the other caches, so as to instruct the first host system to control the one or more other processors to continue processing second remaining data according to the processing logic data, where the second remaining data is data remaining after the second processor processes the first data.

It is to be noted that, each of the above modules may be realized by software or hardware. For the latter, the each of the above modules may be realized by, but is not limited to, the following way: all of the above modules are in the same processor; or, the above modules are respectively in different processors in form of any combination.

The embodiments of the present disclosure further provide a computer non-volatile readable storage medium, in which a computer program is stored. The computer program, when running on a processor, is configured to execute operations in any one of the above method embodiments.

In an exemplary embodiment, the computer non-volatile computer readable storage medium may include, but is not limited to, a U disk, an ROM, an RAM, a mobile hard disk, a magnetic disk, a compact disc, and other media capable of storing the computer program.

The embodiments of the present disclosure further provide an electronic device, which includes a memory and a processor. A computer program is stored in the memory, and the processor is configured to run the computer program to execute operations in any of the above method embodiments.

In an exemplary embodiment, the electronic device may further include a transmission device and an input/output device. The transmission device is connected with the above processor, and the input/output device is connected to the above processor.

The examples in the present embodiment may refer to the above embodiments and the examples described in the exemplary implementations, which will not be elaborated herein.

It is apparent that those having ordinary skill in the art should appreciate that the above modules and operations of the present disclosure may be implemented by a general-purpose computing apparatus, and they may be centralized in a single computing apparatus or distributed on a network composed of multiple computing apparatuses; they may be implemented by a program code which is capable of being executed by the computing apparatus, so that they may be stored in a storage apparatus and executed by the computing apparatus; and in some situations, the presented or described operations may be executed in an order different from that described here; or they are made into integrated circuit modules, respectively; or multiple modules and operations of them are made into a single integrated circuit module to realize. In this way, the present disclosure is not limited to any particular combination of hardware and software.

The above are only the preferred embodiments of the present disclosure, and are not intended to limit the present disclosure, and for those having ordinary skill in the art, various modifications and changes may be made to the present disclosure. Any modifications, equivalent substitutions, improvements, etc. within the scope of the present disclosure shall be included in the principle of the present disclosure.

1. A data processing method, applied to a Compute Express Link (CXL) switch device, and comprising:
receiving a first fault instruction sent by a controller, wherein the first fault instruction is used for indicating that a fault occurs on a first host system, the first host system is configured to control a first processor to process first data, the first processor is an accelerator allocated to the first host system by the CXL switch device, and the CXL switch device is a device that supports a CXL protocol, which is an open interconnection standard;
acquiring first target data based on the first fault instruction, wherein the first target data comprises processing logic data according to which the first processor processes the first data, and first result data obtained after the first processor processes the first data; and
transmitting the first target data to a second host system to instruct the second host system to control a second processor to continue processing the first data according to the first target data, wherein the second host system is a host system in a normal operating state among a plurality of host systems connected to the CXL switch device, and the second processor is a processor allocated to the second host system by the CXL switch device.

2. The data processing method according to claim 1, wherein receiving the first fault instruction sent by the controller comprises:
receiving the first fault instruction sent by a target processor in the controller;
wherein the target processor is connected to a baseboard management controller, the baseboard management controller is connected to the plurality of host systems, and is configured to monitor operating states of the plurality of host systems, and send, when the plurality of host systems comprise a faulty host system, a faulty operating state of the faulty host system to the target processor, the target processor is configured to generate a fault instruction based on the faulty operating state, and the fault instruction comprises system information corresponding to the faulty host system.

3. The data processing method according to claim 1, wherein acquiring the first target data based on the first fault instruction comprises:
in response to the first fault instruction, acquiring the processing logic data from a first memory corresponding to the first host system, and acquiring the first result data from a first cache corresponding to the first processor, wherein the first memory is a memory in an idle state in an expanded memory allocated to the first host system by the CXL switch device, and the expanded memory is connected to the CXL switch device through a CXL link.

4. The data processing method according to claim 1, wherein transmitting the first target data to the second host system to instruct the second host system to control the second processor to continue processing the first data according to the first target data comprises:
storing the processing logic data in a second memory corresponding to the second host system, and storing the first result data in a second cache corresponding to the second processor, so as to instruct the second host system to control the second processor to continue processing first remaining data according to the processing logic data, wherein the first remaining data is data remaining after the first processor processes the first data, the second memory is a memory in an idle state in an expanded memory allocated to the second host system by the CXL switch device, and the expanded memory is connected to the CXL switch device through a CXL link.

5. The data processing method according to claim 4, wherein after storing the first target data in the second memory corresponding to the second host system to instruct the second host system to control the second processor to continue processing the first remaining data according to the processing logic data and the first result data, the data processing method further comprises:
caching, in the second cache, a current processing result obtained after the second processor processes the first remaining data and the first result data.

6. The data processing method according to claim 1, wherein after acquiring the first target data based on the first fault instruction, the data processing method further comprises:
allocating a first memory corresponding to the first host system to one or more other host systems, wherein the one or more other host systems are one or more host systems in the normal operating state other than the first host system among the plurality of host systems connected to the CXL switch device, and the one or more other host systems comprise the second host system; and
allocating the first processor to the one or more other host systems.

7. The data processing method according to claim 1, wherein after acquiring the first target data based on the first fault instruction, the data processing method further comprises:
receiving a fault recovery instruction sent by a programmable logic device in the controller, wherein the fault recovery instruction is used for indicating that the fault on the first host system has been repaired and the first host system is currently in the normal operating state;
in response to the fault recovery instruction, allocating one or more other processors to the first host system, wherein the one or more other processors are one or more processors in an idle state among a plurality of processors connected to the CXL switch device, and the one or more other processors correspond to one or more other caches; and
allocating one or more other memories to the first host system, wherein the one or more other memories are one or more memories in an idle state in an expanded memory connected to the CXL switch device.

8. The data processing method according to claim 7, wherein after allocating the one or more other memories to the first host system, the data processing method further comprises:
when the second host system is currently in a state of processing the first data, acquiring second target data from the second host system, wherein the second target data comprises the processing logic data, second result data obtained after the second processor continues processing the first data, and the first result data; and
transmitting the second target data to the first host system to instruct the first host system to control the one or more other processors to continue processing the first data according to the second target data.

9. The data processing method according to claim 8, wherein transmitting the second target data to the first host system to instruct the first host system to control the one or more other processors to continue processing the first data according to the second target data comprises:
storing the processing logic data in the one or more other memories, and storing the second result data and the first result data in the one or more other caches, so as to instruct the first host system to control the one or more other processors to continue processing second remaining data according to the processing logic data, wherein the second remaining data is data remaining after the second processor processes the first data.

10. A switching board, comprising: a Compute Express Link (CXL) switch device and a plurality of device interfaces, wherein
the plurality of device interfaces are configured to allow, under control of the CXL switch device, a controller, a plurality of host systems, an expanded memory, and a plurality of processors to access the CXL switch device; and
the CXL switch device is configured to perform the data processing method according to claim 1.

11. A data processing system, comprising: a switching board, a controller, a plurality of host systems, an expanded memory, and a plurality of processors, wherein
a Compute Express Link (CXL) switch device and a plurality of device interfaces are deployed on the switching board, the plurality of device interfaces are configured to allow, under control of the CXL switch device, the controller, the plurality of host systems, the expanded memory, and the plurality of processors to access the CXL switch device, and the CXL switch device is configured to perform the data processing method according to claim 1; and
the controller is configured to send a first fault instruction to the CXL switch device, wherein the first fault instruction is used for indicating that a fault occurs on a first host system among the plurality of host systems, the first host system is configured to control a first processor to process first data, and the first processor is an accelerator allocated to the first host system by the CXL switch device from the plurality of processors.

12. The data processing system according to claim 11, wherein the controller comprises a target processor and a baseboard management controller, wherein
the baseboard management controller is connected to the plurality of host systems, and is configured to monitor operating states of the plurality of host systems, and send, when the plurality of host systems comprise a faulty host system, a faulty operating state of the faulty host system to the target processor; and
the target processor is configured to generate a fault instruction based on the faulty operating state, wherein the fault instruction comprises system information corresponding to the faulty host system.

13. The data processing system according to claim 12, wherein
the baseboard management controller is further configured to monitor the first host system through a plurality of signals, and send the faulty operating state of the first host system to the target processor when the plurality of signals all indicate that a fault occurs on the first host system; and
the target processor is configured to generate the first fault instruction based on the faulty operating state of the first host system.

14. The data processing system according to claim 13, wherein
the baseboard management controller is further configured to restart the first host system, and send a fault recovery instruction to the target processor when the first host system is restarted, wherein the fault recovery instruction is used for indicating that the fault on the first host system has been repaired and the first host system is currently in a normal operating state.

15. The data processing system according to claim 14, wherein the controller further comprises a programmable logic device, wherein
the programmable logic device is connected to the target processor and is configured to receive the fault recovery instruction sent by the target processor, and send the fault recovery instruction to the CXL switch device to instruct the CXL switch device to switch from a second host system to the first host system to continue processing the first data.

16. The data processing system according to claim 11, wherein
the CXL switch device is further configured to allocate memories and processors to the plurality of host systems, wherein the allocated memories are memories in an idle state in the expanded memory, and the allocated processors are processors in an idle state among the plurality of processors.

17. The data processing system according to claim 11, wherein the expanded memory, the plurality of processors, and the plurality of host systems are all allowed to be connected to the plurality of device interfaces through CXL links under the control of the CXL switch device.

18-19. (canceled)

20. A computer non-volatile readable storage medium, in which a computer program is stored, wherein the computer program is executed by a processor to implement operations comprising:
receiving a first fault instruction sent by a controller, wherein the first fault instruction is used for indicating that a fault occurs on a first host system, the first host system is configured to control a first processor to process first data, the first processor is an accelerator allocated to the first host system by the CXL switch device, and the CXL switch device is a device that supports a CXL protocol, which is an open interconnection standard;
acquiring first target data based on the first fault instruction, wherein the first target data comprises processing logic data according to which the first processor processes the first data, and first result data obtained after the first processor processes the first data; and
transmitting the first target data to a second host system to instruct the second host system to control a second processor to continue processing the first data according to the first target data, wherein the second host system is a host system in a normal operating state among a plurality of host systems connected to the CXL switch device, and the second processor is a processor allocated to the second host system by the CXL switch device.

21. An electronic device, comprising a memory, a processor, and a computer program stored in the memory and executable on the processor, wherein the processor implements operations comprising:
receiving a first fault instruction sent by a controller, wherein the first fault instruction is used for indicating that a fault occurs on a first host system, the first host system is configured to control a first processor to process first data, the first processor is an accelerator allocated to the first host system by the CXL switch device, and the CXL switch device is a device that supports a CXL protocol, which is an open interconnection standard;
acquiring first target data based on the first fault instruction, wherein the first target data comprises processing logic data according to which the first processor processes the first data, and first result data obtained after the first processor processes the first data; and
transmitting the first target data to a second host system to instruct the second host system to control a second processor to continue processing the first data according to the first target data, wherein the second host system is a host system in a normal operating state among a plurality of host systems connected to the CXL switch device, and the second processor is a processor allocated to the second host system by the CXL switch device.

22. The data processing method according to claim 1, wherein the processing logic data of the first data includes one or more operations required to be performed for processing the first data.
